(19) United States
(12) Patent Application Publication
(10) Pub. No.: US 2009/0087527 A1
(43) Pub. Date: Apr. 2, 2009

(54) SHREDDED READY-TO-EAT CEREAL WITH OATS

(76) Inventors: Michael E. Belanger, Richland, MI (US); Douglas Eugene Brooks, Ceresco, MI (US); Maria Denelle Ruhlman, Battle Creek, MI (US); Zarini Tahir, Kalamazoo, MI (US)

Correspondence Address: Randall L. Shoemaker;Dickinson Wright PLLC, Ste. 2000, 38525 Woodward Ave., Bloomfield Hills, MI, 48304-2970, US

(21) Appl. No.: 12/241,341

(22) Filed: Sep. 30, 2008

Related U.S. Application Data
(60) Provisional application No. 60/976,458, filed on Sep. 30, 2007.

(51) Int. Cl. A23L 1/168; A23L 1/01; A23L 1/30; A23L 1/302; A23L 1/22; A23B 4/03

(52) U.S. Cl. 426/311; 426/509; 426/650; 426/622; 426/452; 426/620

(57) ABSTRACT

A method of producing cooked cereal grains containing a high level of whole oats for a shredded ready-to-eat cereal. The method begins by disposing a whole grain oat into a mixer. The whole grain oat has an exposed first starch. Next, a second whole grain is disposed into the mixer. The second whole grain has an exposed second starch that is different from the first starch. A third starch is disposed into the mixer to act as a binder of the whole grain oat and second whole grain. Water is added to the mixer to form a mixture that is cooked to form cooked cereal grains containing high levels of whole oats. The cooked grains are shredded and layered to form a shredded wheat-like biscuit.

### CROSS-REFERENCE TO RELATED APPLICATIONS

This application claims the benefit of U.S. Provisional Patent Application Ser. No. 60/976,458 for a SHREDDED READY-TO-EAT CEREAL WITH OATS, filed on Sep. 30, 2007, which is hereby incorporated by reference in its entirety.

### BACKGROUND OF THE INVENTION

1. Field of the Invention

The invention relates to a method of preparing a shredded ready-to-eat (RTE) cereal and particularly to a method of producing cooked cereal grains containing a high level of whole oats for the shredded ready-to-eat cereal.

2. Description of Related Prior Art

Shredded cereals are known in the art, particularly shredded whole wheat cereals. In shredding, the base material is milled into fine fibers and the fibers are overlaid with respect to one another to form a sheet. The sheets are then overlaid with respect to one another and the resulting laminate is then cut into individual RTE cereal pieces.

The value of oat grains, particularly oat groats, has long been appreciated. Oat groats are high in protein and are a good source of vitamins and minerals. However, difficulties are encountered in the production of oat food products having desired qualities from the standpoint of the consumer. For example, oat foods have a tendency when cooked to paste or form lumps. These tendencies have made the shredding of oats difficult.

This problem was addressed in U.S. Pat. No. 4,734,294 (hereinafter the '294 patent) to Spiel et al. The '294 patent discloses a process for the production of shredded oat food products, such as ready-to-cat breakfast cereals having the shredded appearance and texture of shredded whole wheat. The '294 patent was concerned with white streaks or spots in the final product, which resulted from uncooked or overcooked grains. To solve the problem, the '294 patent pressure cooked the oats in at least two stages in order to prepare the oats for a mixture for shredding.

This problem was further addressed in U.S. Pat. No. 4,497,840 (hereinafter the '840 patent) to Gould et al. The '840 patent discloses the use of multiple mechanical means, such as, an extruder and a series of mills to produce a homogenous oat bran mixture for shredding. The cooked, shredded oat bran in accordance with the '840 patent is eminently suitable for use as an “instant” cereal food product. The product was not a shredded wheat-like biscuit.

### SUMMARY OF THE INVENTION

In summary, the present invention is a method of producing cooked cereal grains containing a high level of whole oats for a shredded ready-to-eat cereal. The method begins by disposing a whole grain oat into a mixer. The whole grain oat has an exposed first starch. Next, a second whole grain is disposed into the mixer. The second whole grain has an exposed second starch that is different from the first starch. A third starch is disposed into the mixer to act as a binder of the whole grain oat and second whole grain. Water is added to the mixer to form a mixture that is cooked to form the cooked cereal grains containing a high level of whole oats. The grains are shredded and layered to form a shredded wheat-like biscuit.

### BRIEF DESCRIPTION OF THE DRAWING

Advantages of the present invention will be readily appreciated as the same becomes better understood by reference to the following detailed description when considered in connection with the accompanying drawings wherein;

FIG. 1 is a schematic for a process to produce the RTE cereal piece according to an exemplary embodiment of the invention;

FIG. 2 is a simplified flow diagram illustrating the steps of an exemplary embodiment of the invention;

FIG. 3 is a perspective view of a product produced in an exemplary embodiment of the subject invention; and

FIG. 4 is a side view of the product shown in FIG. 4 and having an internal filling.

### DETAILED DESCRIPTION OF THE EXEMPLARY EMBODIMENT

A ready-to-eat (RTE) cereal piece 20 according to the exemplary embodiment of the invention is formed from a whole grain oat, a second whole grain and resistant starch. The whole grain oat portion of the RTE cereal piece 20 is generally in the form of whole oat groats, but may include bran in combination with the oat groats. The whole grain oat portion of the RTE cereal piece 20 imparts desirable levels of Beta-glucan to the RTE cereal piece 20. The selection between groats and bran or the ratio of a combination of groats and bran can be made in view of the desired level of Beta-glucan in the RTE cereal piece 20. It is also noted that forms of bran other than oat bran can be used to practice the invention, such as whole white wheat bran, corn bran and red wheat bran. For a combination, the ratio can be selected in view of the manufacturability of the combination, for making a shredded RTE cereal piece 20. For example, Beta-glucan is relatively more concentrated in oat bran than in groats; therefore it may be desirable to include oat bran with oat groats to boost Beta-glucan content.

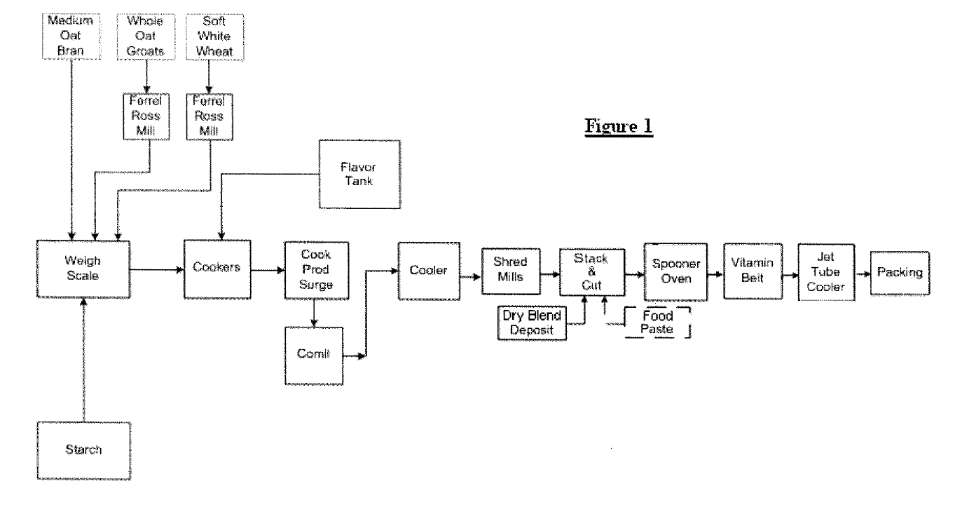

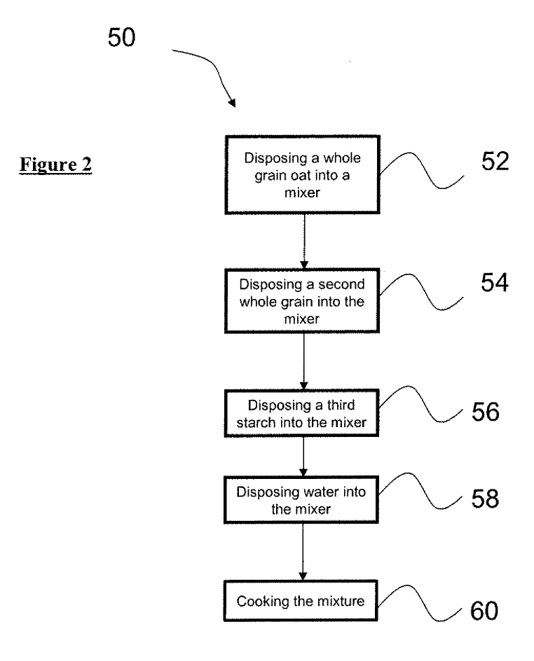

FIGS. 1 and 2 show an exemplary process schematic and a method flow chart of an exemplary embodiment of the invention. The method 50 of producing cooked cereal grains containing a high level of whole oats for a shredded ready-to-eat cereal begins with the step 52 of disposing the whole grain oat with an exposed first starch into a mixer. A separate mixer may be used to mix the ingredient prior to cooking, or the ingredients may be mixed in the cooker prior to cooking. In step 54 of the exemplary embodiment, a second whole grain with an exposed second starch is disposed into the mixer. The second starch is different from the first starch.

In the exemplary embodiment, the whole grain oat is oat groats and the second whole grain is soft white wheat. The whole grain oat portion of the RTE cereal piece 20 is generally oat groats, but may be any oat product known in the art. The second whole grain portion of the RTE cereal piece 20 is generally a wheat but can be in any wheat known in the art, including but not limited to, soft white wheat.

The oat groats and soft white wheat are processed, such as milled or cut, to expose the first and second starches to be combined with a third starch. In the exemplary embodiment a Ferrel Ross mill may be used to mill or cut the oat groats and soft white wheat. Any mill or cutter known in the art may be used to mill, cut or bump the oat groats and soft white wheat. Additionally, both the oat groats and wheat may be purchased with the first and second starches already exposed. For example, one may purchase a stabilized oat ingredient. For example, oats may be stabilized by steaming dehulled, whole or dried oat groats which generally contain on the order of 10%-12% moisture for a suitable period. The oat groats are steamed in suitable steaming equipment at temperatures of about 210° F.-215° F. and pressures of about 14.7 to 18 psi. After steaming, the oat kernels are passed through “bump” rolls with the clearance between the rolls being sufficient to break or fracture the kernels but insufficient to roll the oat kernels. Bumping of the oat kernels expose the first starch. The oat kernels may be bumped, milled or cut after they are purchased to further expose the first starch. Additionally, the pre-cut wheat may be bumped, milled or cut after it is purchased to further expose the second starch.

The whole grain oat, more specifically, the milled oat groats constitute about 25% 60%, preferably 42%-46% of the mixture on a dry weight basis. Oat bran may be combined with the milled oat groats and the oat bran alone can constitute about 3%-5% of the mixture on a dry weight basis. Oat bran is used in limited amounts, if at all, because it is enriched in protein, fat, crude fiber, ash, dietary fiber and gum content which affect the shreddability of the mixture. In addition to the optional oat bran, any ingredient known in the art to be difficult to shred, such as soybeans or other legumes, may be added to the mixture.

The second whole grain or milled wheat portion, more specifically, the milled soft white wheat constitutes about 20%-45%, preferably 35%-39% of the mixture on a dry weight basis. It is preferred that the whole grain oat constitutes a greater portion of the mixture than the second whole grain. Inclusion of the second whole grain, particularly wheat, is desirable to enhance the shredability of the mixture.

In step 56 of the exemplary method, a third starch is disposed into the mixer to bind the whole grain oat and second whole grain. The third starch constitutes about 2%-20%, preferably 8%-15% of the mixture on a dry weight basis. The third starch of the RTE cereal piece 20 can be any resistant starch known in the art, including but not limited to corn starches such as Resistant Corn, Hi-Maze 260 and Resistant Corn, Hi-Maze 220. National Starch describes Hi-maize 220 as an unmodified high amylose corn starch which contains approximately 70% amylose. Hi-maize 220 is used in a variety of food applications where it contributes dietary fiber. National Starch further describes Hi-maize 220 as a resistant starch. A portion of this starch is resistant to digestion in the small intestine and is subsequently fermented in the large intestine. In this way, Hi-maize 220 displays some of the physiological aspects of dietary fiber. Hi-maize 220 is technically classified as an RS2-type resistant starch. Inclusion of the third starch is desirable to enhance the shredability of the mixture. Resistant starches are preferred because they are low in protein, fat, and ash which affect the shredability of a mixture. The inclusion of this resistant third starch solves the problem of lumps and paste in preparing high oat containing cooked grains and allows for a shredded product.

The method of the exemplary embodiment, includes the optional step of adding an additive to the mixture. The additive may include any additive known in the art, including but not limited to, nutritional supplements such as vitamins and minerals, flavoring enhancers such as salt, and sweeteners such as sugar or corn syrup, artificial sweeteners, soybeans or legumes. Any ingredient commonly included in shredded cereals can be added to the mixture of the exemplary embodiment as desired.

In step 58 of the exemplary method, water is disposed into the mixer to from a mixture. Water constitutes about 25%-45%, more preferably 26%-30% of the mixture by weight.

In step 60 of the exemplary method, the mixture is cooked to form the cooked cereal grains. The mixture is cooked in a primary cooker. Any cooker known in the art may be used, including but not limited to a rotary cooker. The mixture is cooked to a temperature of about 200° F.-220° F., preferably to about 210° F.-214° F. so not to overgelatinize the starches in the mixture. The moisture content of the cooked cereal grains following cooking is about 32%-48%, preferably 36%-42%.

The cooked cereal grains are then conveyed/surged to a comil. where the cooked cereal grains are separated into pieces or smaller units of cooked grains. The mass is separated to distribute the cooked grains into more workable size pieces for shredding. The cooked mass may be separated into smaller units by any method known in the art. The comil. can also enhance the distribution of the third starch in the mixture.

Next, the smaller units of cooked cereal grains may be cooled prior to shredding. Cooling may be accomplished by any means known in the art. In an exemplary embodiment, the smaller units of cooked grains are cooled by convection with ambient air. However, the cooling can also be achieved by a cooling conveyor belt or by other suitable cooling methods.

The cooled, smaller units of cooked grains are then shredded. The smaller units of cooked grains may be shredded by any means known in the art of shredding. Shredding systems which can be used in the process of the present invention may comprise conventional rolls and devices such as that indicated in U.S. Pat. No. 4,004,035 to Hirzel et al., which is hereby incorporated by reference in its entirety.

The Hirzel patent discloses a shredding system having one or more conventional shredding mills comprising a pair of closely spaced rolls. The rolls are rotated toward one another, and cooked cereal grains are passed therebetween causing the cooked cereal grains to be elongated into a plurality of individual strands or shreds. The resulting stream of shredded material is layered or stacked and cut into individual RTE cereal pieces 20. The individual shreds are then lapped or layered to form the sheets of layered shreds. A typical biscuit, for example, may contain up to 21 individual layers of shreds. Upon obtaining the requisite thickness, the sheeted shreds may be cut transversely and longitudinally into multiple lines of biscuits or individual RTE cereal pieces 20 in any known manner.

The oat particles are transferred to a series of conventional shredding rolls or mills via flow tubes or hoppers. The shreds, which can be produced in the form of net-like sheets by each set of shredding rolls, are layered, cut, dried, baked, toasted, and then the pieces are packaged all in a known manner as for the production of shredded whole wheat biscuits.

During stacking or layering, an enhancer 22, such as an additive or filling, to enhance flavoring, nutritional value or appearance of the ultimately produced RTE cereal piece 20 can be injected or inserted between the layers of individual stranded shreds. Dry blend and food paste enhancers 22 are shown in the exemplary schematic and may be applied by any method known in the art. For example, the enhancers 22 may be applied by a plurality of equi-spaced discharge tubes that extend from a header and supply spaced continuous longitudinal ribbons of filling between the layer of individual stranded shreds. Other types of filling devices may be employed, including a device for depositing a sheet of fill material uniformly across the individual stranded shreds, or a device for applying intermittent deposits of material.

The individual RTE cereal pieces 20 are then dried and toasted in a spooner oven. Exemplary of the types of dryers which can be used to additionally dry the individual RTE cereal pieces 20 are belt or conveyor dryers, vacuum dryers and the like. In the exemplary embodiment, the individual RTE cereal pieces 20 are toasted or heated in a spooner oven, but any oven known in the art may be used.

After the individual RTE cereal pieces 20 have been toasted, a second additive may be added to the individual RTE cereal pieces 20. For example, the individual RTE cereal pieces 20 may be ran along a vitamin belt where they are sprayed with flavoring, artificial sweeteners, and/or sweeteners, such as frosting.

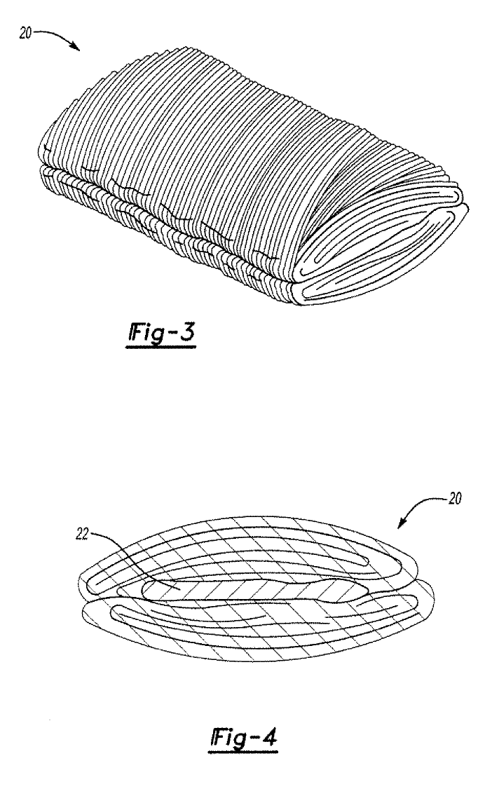

The individual RTE cereal pieces 20 are then cooled and packaged. Cooling may be accomplished by any means known in the art. In an exemplary embodiment, the individual RTE cereal pieces 20 cooled by convection with ambient air. However, the cooling can also be achieved by a cooling conveyor belt or by other suitable cooling methods. The final individual RTE cereal pieces 20 have a shredded-like appearance as shown in FIGS. 3 and 4.

The RTE cereal pieces 20 produced by the exemplary process comprise Beta-glucan in an amount greater than 0% and less than 15%, by weight of the RTE cereal piece 20. It is believed that the RTE cereal pieces 20 produced by the exemplary process comprises Beta-glucan in an amount of about 3% to about 7%. Thus, the RTE cereal 20 produced by the exemplary process is distinguished over shredded wheat RTE cereal pieces 20 by the inclusion of whole grain oat. The RTE cereal pieces 20 produced by the exemplary process is also distinguished over shredded wheat RTE cereal pieces by providing an alternative texture and taste.

The foregoing invention has been described in accordance with the relevant legal standards, thus the description is exemplary rather than limiting in nature. Variations and modifications to the disclosed embodiment may become apparent to those skilled in the art and do come within the scope of the invention. Accordingly, the scope of legal protection afforded this invention can only be determined by studying the following claims.

What is claimed is:

1. A method of producing cooked cereal grains containing a high level of whole oats for a shredded ready-to-eat cereal comprising the steps of:
disposing a whole grain oat having an exposed first starch into a mixer;
disposing a second whole grain having an exposed second starch different from the first starch into the mixer;
disposing a third starch into the mixer to bind the whole grain oat and second whole grain;
disposing water in the mixer to form a mixture; and
cooking the mixture to form the cooked cereal gains.

2. The method as set forth in claim 1 further comprising the step of milling the whole grain oat to expose the first starch prior to the disposing the whole grain oat into the mixer step.

3. The method as set forth in claim 1 wherein the whole grain oat constitutes about 25%-60% of the mixture on a dry weight basis.

4. The method as set forth in claim 1 wherein the whole grain oat constitutes about 42%-46% of the mixture on a dry weight basis.

5. The method as set forth in claim 1 further comprising the step of milling the second whole grain to expose the second starch prior to the disposing the second whole grain into the mixer step.

6. The method as set forth in claim 1 wherein the second whole grain constitutes about 20%-45% of the mixture on a dry weight basis.

7. The method as set forth in claim 1 wherein the second whole grain constitutes about 35%-39% of the mixture on a dry weight basis.

8. The method as set forth in claim 1 wherein the whole grain oat constitutes a greater portion of the mixture than the second whole grain.

9. The method as set forth in claim 1 wherein the disposing the third starch step is further defined as disposing a corn starch into the mixer to bind the whole grain oat and second whole grain.

10. The method as set forth in claim 9 wherein the corn starch is a high amylose corn starch.

11. The method as set forth in claim 1 wherein the third starch constitutes about 2%-20% of the mixture on a dry weight basis.

12. The method as set forth in claim 1 wherein the third starch constitutes about 8%-15% of the mixture on a dry weight basis.

13. The method as set forth in claim 1 further comprising the step of adding an additive to the mixture.

14. The method as set forth in claim 13 wherein the additive is one of vitamins, minerals, flavoring enhancers, sweeteners, artificial sweeteners, oat bran, whole white wheat bran, corn bran, red wheat bran, soybeans, and legumes.

15. The method as set forth in claim 1 wherein the cooking the mixture step is further defined as cooking the mixture in the mixer to form the cooked cereal grains.

16. The method as set forth in claim 1 wherein the cooking the mixture step is further defined as cooking the mixture to form the cooked cereal grains having a moisture content of about 32%-44%.

17. The method as set forth in claim 1 wherein the cooking the mixture step is further defined as cooking the mixture to form the cooked cereal grains having a moisture content of about 36%-42%.

18. A cooked cereal grains product containing a high level of whole oats made from the process of claim 1.

19. A method of producing a shredded oat ready-to-eat cereal comprising the steps of:
disposing a whole grain oat having an exposed first starch into a cooker;
disposing a second whole grain having an exposed second starch different from the first starch into the cooker;
disposing a third starch into the cooker to bind the whole grain oat and second whole grain;
disposing water in the cooker to form a mixture;
cooking the mixture to form a cooked grains mass;
shredding smaller units of cooked grains to form individual stranded shreds;
layering the individual stranded shreds and cutting the layered shreds to form individual shredded oat ready-to-eat cereal pieces; and
heating the shredded oat ready-to-eat cereal pieces.

20. The method as set forth in claim 19 further comprising the step of adding an additive to the mixture.

21. The method as set forth in claim 20 wherein the additive is one of vitamins, minerals, flavoring enhancers, sweeteners, artificial sweeteners, oat bran, whole white wheat bran, corn bran, red wheat bran, soybeans, and legumes.

22. The method as set forth in claim 19 further comprising the step of separating the mass of cooked grains into the smaller units of cooked grains prior to the shredding step.

23. The method as set forth in claim 19 further comprising the step of cooling the smaller units of cooked grains prior to the shredding step.

24. The method as set forth in claim 19 further comprising the step of inserting an enhancer between the individual stranded shreds.

25. The method as set forth in claim 19 further comprising the step of drying the shredded oat ready-to-eat cereal pieces prior to the heating step.

26. The method as set forth in claim 19 further comprising the step of applying a second additive to the ready-to-eat cereal pieces.

27. The method as set forth in claim 26 wherein the second additive is one of vitamins, flavoring, artificial sweeteners, sweeteners and frosting.

28. A shredded oat ready-to-eat cereal made by the process of claim 19.
